(19) United States
(12) Patent Application Publication
(10) Pub. No.: US 2012/0178856 A1
(43) Pub. Date: Jul. 12, 2012

(54) CELLULOSE FIBERS WITH AN ENHANCED METERING CAPABILITY, PROCESSES FOR THEIR PRODUCTION AND THEIR USE TO REINFORCE COMPOUND MATERIALS

(75) Inventors: Markus Gobl, Seeham (AT); Josef Innerlohinger, Bergim Attergau (AT); Friedrich Suchomel, Schorfling (AT)

(73) Assignee: Lenzing AG, Lenzing (AT)

(21) Appl. No.: 13/394,057

(22) PCT Filed: Jul. 27, 2010
(86) PCT No.: PCT/AT2010/000274

§ 371 Date: Mar. 27, 2012

(30) Foreign Application Priority Data
Sep. 3, 2009 (AT) A 1388/2009
Feb. 24, 2010 (AT) A 286/2010

(51) Int. Cl. C08L 1/02; B02C 18/00; D02G 3/02

(52) U.S. Cl. 524/35; 428/401; 241/30

(57) ABSTRACT

The present invention relates to cellulose fibers with an enhanced metering capability, a process for the production of these and the use of these for the reinforcement of compound materials, in particular thermoplastic polymers.

### BACKGROUND OF THE INVENTION

1. Field of the Invention

The present invention relates to cellulose fibers with enhanced metering capability, a process for their production and their use to reinforce compound materials, in particular thermoplastic polymers.

2. State of the Art

For a long time there have been efforts to replace the glass fibers in compound materials such as fiber-reinforced polymers with lightweight, sustainably produced fibers of cellulose which can be disposed of with ease. First of all it seems self-evident to use natural fibers for this, for example cotton, flax, hemp or other such materials. However, these reveal different problems which are typical for natural fibers. Smells during processing and in part even in the finished product, fogging and yellowing. Moreover, the fiber diameter is limited to approx. 20-35 μm depending on the vegetable origin. Often the individual fibers are still in the form of fiber clusters with a much higher thickness. All of these fluctuations respectively irregularities make processing more difficult on the one hand and often lead to quality problems in the finished compound product.

To even out these disadvantages, different approaches were published to improve the suitability of the natural fibers via an intermediate step. For example Abaca fibers were processed to a card sliver which is then directly fed into an extruder in which the breaking down of the fibers takes place in addition to mixing with the polymer. However, the energy required in the extruder is very high with this process.

Pulp which is gained from wood as a result of a chemical process, however, contains the cellulose in a very pure form. The use of this in compound materials is indeed well-known but the mechanical properties of the products produced in this way do not sufficiently satisfy higher demands as will be shown later by means of a comparative example (example 8).

Another approach is the use of cellulosic man-made fibers. In general the cellulosic man-made fibers to be understood for the purpose of the present invention are cellulosic fibers of the kind obtained from solutions in which the cellulose was available in a dissolved form either in purely physical terms or due to chemical derivatization. The best known representatives of this fiber kind are viscose—and also in particular high-tenacity viscose tire cord—, Modal, Lyocell and Cupro, the designations of which are defined by the terminology of BISFA. These fibers have a high chemical purity, a high regularity and strength and can be produced specifically with the fiber diameters which are required in each case, which would produce an optimum reinforcement effect depending on the purpose of the application. The processing of these is, however, problematic, in particular the metering capability and the regular distribution in the plastic in the processes typical for the compound substances such as for example the extrusion process. The standard fiber types with cutting lengths for textiles, i.e. of about 38 mm, as well as short-cut fibers, i.e. with cutting lengths of about 5 mm cannot be used in the field of plastic reinforcement since they cannot be processed to even products using standard plastics processing machines. One of the main problems is thereby the blocking of the metering equipment of the extruders as a result of fiber entanglements and bridging.

Approaches to solve this problem for example by producing fiber-plastic pellets of endless filament yarns or even card slivers using so-called Pull-Drill processes and/or pultrusion processes did not, until now, produce the desired result. Moreover because of the polymer already contained these mixed bodies cannot be universally applied but are mostly determined for use in the same polymer. For this reason it was not possible until now to make use of the positive properties for example of the Lyocell fibers, such as for example the high tear strength, in the field of plastic reinforcement.

### Task

In the light of these problems, the task was to make cellulosic fiber materials available which can be processed without any problems in the normal plastics processing machines, produce a high quality in the compound materials and can be produced simply and at favorable cost.

### SUMMARY OF THE INVENTION

It was possible to solve this task using cellulosic man-made fibers, which have an average diameter of between 5 and 20 μm and a an average number-weighted length of between 200 and 800 μm. Fibers with a ratio of average length to number-weighted average diameter (L/D) of 30 to 40 were particularly favorable. Longer fibers would no longer be meterable. Shorter fibers would indeed be—apart from a possibly thicker formation of dust—likewise easy to meter but would not provide a sufficient reinforcement effect in the compounds. In addition, these would also be too expensive to produce since they could only be produced with a low throughput in the mill. As a comparison: pulp fibers are considerably thicker with around 20 to 35 μm and, therefore, only reveal low reinforcement effects. Likewise cellulosic man-made fibers can be produced with larger diameters. Thus for example cellulosic man-made fibers with an individual fiber titer of 15 dtex have an average diameter of 35 μm. These thicker fibers have the general advantages already named of man-made fibers, namely a high purity and regularity and can still be readily metered with a longer length due to the higher stiffness, however, for the very same reason they display only a slight reinforcement effect in plastics for the same reason. Short-cut fibers of Viscose or Lyocell, which are already commercially available, are much longer with around 5000 μm.

### BRIEF DESCRIPTION OF THE FIGURES

For a more complete understanding of the present invention, and the advantages thereof, reference is made to the following descriptions taken in conjunction with the accompanying figure, in which

FIG. 1 is a graph showing the length-weighted fiber length distribution of exemplary cellulosic man-made fibers made in accordance with the present invention; and

FIG. 2 is an x-ray photograph showing the even distribution of the powder in the matrix of an exemplary compound body.

### DETAILED DESCRIPTION OF THE INVENTION

The average diameter of the fibers in accordance with the invention normally corresponds to the starting fibers since this is not considerably changed during production, as is described below.

The fibers in accordance with the invention are extremely suitable for use in fiber-reinforced plastics. Due to their high mechanical strengths, Modal and Lyocell fibers, i.e. fibers with a tenacity (conditioned) of at least 35 cN/tex, are given preference. Endless fibers made for tire cord, which have a high mechanical strength, are also conceivable. All of these fibers display a modulus of at least 10 GPa (determined according to Lenzing Standard TIPQA 03/06 on the dry individual fibers using a Vibrodyn measuring device with a preload of 50 mg). Fibers with a tenacity (conditioned) of at least 35 cN/tex and a modulus of at least 10 GPa should be designated as “high tenacity” for the purposes of the present invention. Lyocell fibers are given particular preference. Standard viscose fibers are basically likewise also suitable for reinforcing plastics but due to their much lower tenacity of approx. 21 cN/tex, a much lower reinforcement effect is to be expected.

As a matrix polymer of a compound material of this kind, basically all types of thermoplastic polymers are suitable i.e. both crude oil-based ones as well as those based on renewable raw materials. The different polyolefines are wide spread such as homo- or copolymers of polyethylene and polypropylene as well as their blends. Likewise the other crude-oil based polymers can be used such as polyester, polyamide, polystryrene as well as thermoplastic elastomers (TPE) and other impact-resistant modified polymers. Today products produced on the basis of renewable raw materials and/or bio-degradable polymers such as for example polylactic acid (PLA), blends of co-polyester and PLA, polyhydroxyalcanoate (PHA) (an example from this group is polyhydroxybutyrate (PHB), starch and starch-based polymers, polyvinylalcohol-co-vinylacetate-copolymers, polyvinylalcohols, (PVA, e.g. Mowiol®), polyvinylbutyrale (PVB, e.g. Mowital®) and polytrimethyleneterephthalates produced using renewable raw materials (e.g., Sorona®). Likewise the different polymers marketed under the brand name of BioMax® are suitable which contain thermoplastic starch (TPS) and/or polytrimethyleneterephthalates made using renewable raw materials, Mater-Bi®, a bio-degradable blend of starch and polyester in which the polyester is mainly based on renewable raw materials and NAWAPUR®, a foam which contains a polyol on the basis of renewable raw materials.

The subject matter of the present invention is, therefore, also the use of cellulosic man-made fibers of this kind which reveal an average diameter of between 5 and 20 μm and a number-weighted average length of between 200 and 800 μm for the production of compound materials of thermoplastic polymers whereby the fibers are metered into a mixing aggregate where they are evenly distributed in the thermoplastic polymer.

The subject matter of the present invention is last but not least also compound materials of thermoplastic polymers which contain the cellulosic man-made fibers described above, which have an average diameter of between 5 and 20 μm and a number-weighted average length of between 200 and 800 μm. Surprisingly the cellulosic man-made fibers are evenly distributed in the thermoplastic polymer.

The fibers in accordance with the invention are short enough to be able to be metered using standard equipment. At least they are moderately pourable. Otherwise the meterability is otherwise only slight for fibers this thin due to the flexibility and as a result of the fiber entanglements which follow from this. Thicker (natural) fibers tend to be more pourable since they are stiffer.

However, the low fiber diameter produces clear advantages in the plastic reinforcement as these examples also show. Likewise the fact that a considerable share of fibers with a length of over 1 mm are contained in the powder, has a positive effect on the reinforcement. The examples show that the mechanical values of compounds of Lyocell fibers in accordance with the invention in a polypropylene matrix are almost identical with that of workpieces for which 8 mm long, commercially available short-cut fibers were used. To sum up, it can be stated that with the fibers in accordance with the invention, an optimum compromise is given between the reinforcement effect and meterability.

Another advantage when using fibers in accordance with the invention compared to natural fibers is the continuously high quality which is guaranteed by the fact that cellulosic man-made fibers are produced using an industrial process and weather and climate fluctuations have no influence on the dimension and properties of the fibers which is not the case with natural fibers. Since the fibers in accordance with the invention are made of highly pure cellulose, the problem of smell known for example from natural fibers when processing these (and also in part later in the workpiece) does not occur in the use in accordance with the invention in compounds. Phenomena such as fogging or yellowing are likewise negligible.

The fibers in accordance with the invention can be made of pure cellulose when they were produced by grinding standard fibers. Apart from this, modified fibers are also possible when they were produced by grinding correspondingly modified starting fibers. These modified fibers can for example be chemically derived or can contain spun in i.e. incorporated additives. In the same way one can use starting fibers with non-round cross-sections. Suitable fiber types are for example those with trilobal cross-sections as these are described in WO 2006/060835 or band-like fibers with a rectangular cross-section. All of these variants are only possible due to the preceding forming process from the spinning solution. In particular the incorporation of additives cannot be realized in this from with natural fibers or pulp; here only a surface application is possible. For this reason, it is possible to make fibers available using the present invention which for example mix in even better in the plastic matrix and or have other functionalities. A purely surface application of additives is of course also possible with fibers in accordance with the invention.

The compound material can contain other fiber materials, in particular pulp and/or natural fibers, in addition to the cellulosic man-made fibers. The selection of a mixture of this kind basically depends on the planned application of the compound material and the material requirements derived from this. In particular other fiber materials can be added for cost reasons. Thus for example it is also possible to add glass fibers. The positive reinforcing effect of the ground cellulosic man-made fibers in accordance with the invention remains intact even in the event of additives of this kind.

Another subject matter of the present invention is a process for the production of man-made fibers in accordance with the invention, which comprises the following steps:

a) Providing commercially available textile cellulosic man-made fibers with an average diameter of between 5 and 20 μm and a length of between 5 and 200 mm, preferably between 20 and 60 mm

b) Comminuting of the man-made fibers using a precision cutting mill

Shorter starting fibers cannot be applied in an economic way since due to the high efforts for cutting the productivity which can be achieved in their production is not high enough. For this reason it has to be considered that the present invention only makes economic sense when textile standard fibers can be used as the starting material. The fiber length will finally be determined by the aperture width of the sieve used in the precision cutting mill. The resulting number-weighted average length of the man-made fibers in accordance with the invention normally corresponds to the aperture width of the sieve used.

Different models can be considered as a precision cutting mill. A well suited aggregate is for example cutting mill PSC 5-10 from Messrs. Pallman. An important criterion to select a suitable cutting mill is that the fibers are exclusively shortened in the length and the fiber diameter is kept constant. Fibrillation in the fibers has to be avoided during grinding since this will lead to dust formation and to a considerable deterioration in meterability. As a starting material, textile standard fibers (for example 1.3 dtex/38 mm) can preferably be used. That the selection of the suitable grinding aggregate is nonetheless still not a trivial problem can be seen by the fact that other grinding tests such as for example at Hosokawa Alpine were not successful. For the selection of suitable aggregates, it is above all important to avoid lumps and high thermal loads of the grinding material. To avoid lumps and high thermal loads of the grinding material, the use of a correspondingly optimized finishing agent is important.

In a preferred embodiment of the invention the starting fibers can already be provided by the fiber manufacturer where the starting fibers can be placed in the cutting mill in accordance with the invention directly after their production and post-treatment, respectively after drying. In this respect, the intermediate step of bale pressing and opening is not necessary.

A second preferred embodiment of the process in accordance with the invention consists of the provision of the fibers—mostly in a location different from that of the fiber manufacturer—in step a) in bale form. In this case, the fibers should be opened by means of a bale opener prior to comminuting. In this respect machines well known in the textile industry can be used for this. One difficulty in practice will be that the companies who perform the process in accordance with the invention, are normally not textile companies but rather those working in the plastics processing industry and they do not therefore automatically have a bale opener at their disposal. Depending on the consistency of the fibers and the bales, however, a shredder or a similar aggregate can be suitable for opening the pressed fibers.

### EXAMPLES

The invention should now be explained by mean of examples. These are to be understood as possible embodiments of the invention. In no way is the invention restricted to the scope of these examples.

The fiber lengths and the fiber length distributions were measured with a MorFI Fiber Analyzer from the Techpap Company, France. The average fiber diameters of the starting fibers were determined using a Vibrodyn Fiber Analyzer to determine the titer and to convert the titer into the diameter by means of the density. When grinding the starting fibers using the process in accordance with the invention, the fiber diameter does not change as it was possible to determine by testing this under the light optical microscope.

### Example 1

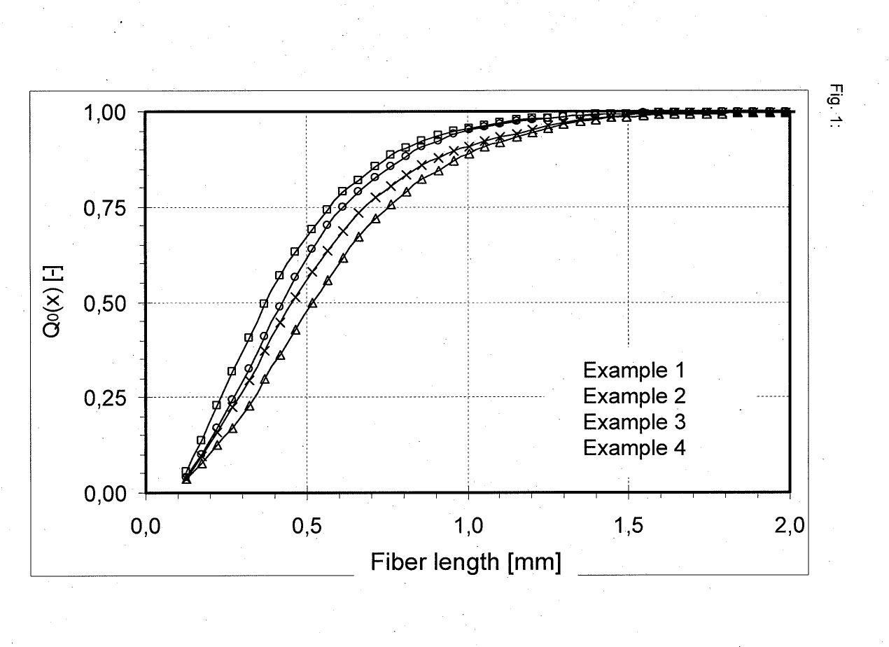

Standard textile fibers of Lyocell (TENCEL® of Lenzing AG) with an individual fiber titer of 0.9 dtex and a cut length of 38 mm was ground in a cutting mill PSC 5-10 by the Pallmann company, equipped with a sieve with an aperture width of 0.35 mm. The powder obtained comprised fibers with an average diameter of 9 μm and a number-weighted average fiber length of 300 μm. The length-weighted fiber length distribution is shown in FIG. 1

### Example 2

Standard textile fibers of Lyocell (TENCEL® of Lenzing AG) with an individual fiber titer of 1.3 dtex and a cut length of 38 mm were ground in a cutting mill PSC 5-10 of the Pallmann Company, equipped with a sieve with an aperture width of 0.35 mm. The powder comprised fibers with an average diameter of 10 μm and a number-weighted average fiber length of 350 μm. The length-weighted fiber length distribution is shown in FIG. 1.

### Example 3

Example 2 was repeated but with a sieve with an aperture width of 0.50 mm. The powder obtained contained fibers with an average diameter of 10 μm and a number-weighted average fiber length of 400 μm. The length-weighted fiber length distribution is shown in FIG. 1.

### Example 4

### Comparative Example

Loose Lyocell fibers (TENCEL® of Lenzing AG) with an individual fiber titer of 15 dtex and a cut length of 15 mm (special type) were ground in a cutting mill PSC 5-10 of the Pallmann company, equipped with a sieve with an aperture width of 1.8 mm. The powder obtained comprised fibers with an average diameter of 35 μm and a number weighted average fiber length of 500 μm. The length-weighted fiber length distribution is shown in FIG. 1.

### Example 5

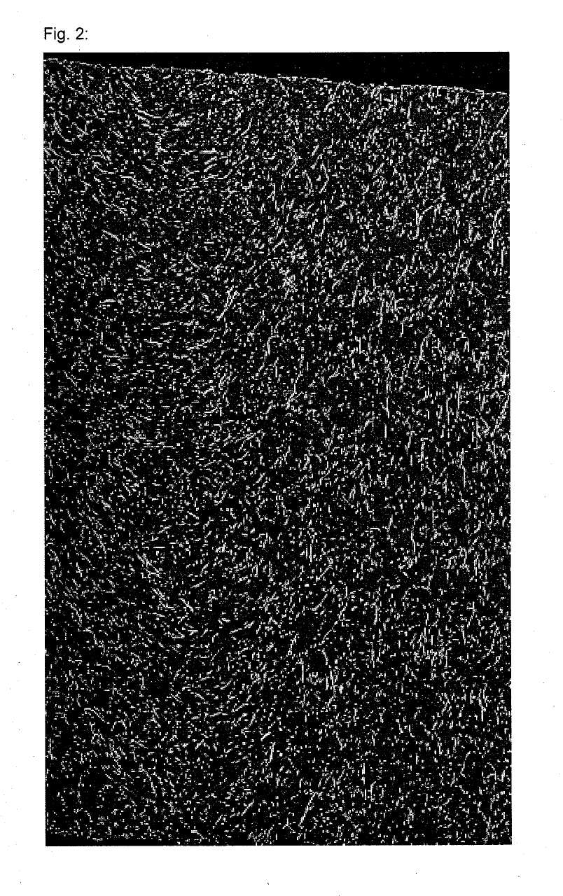

20 weight percentage of the regenerated cellulose powder obtained in example 3 was blended in to an extruder Thermoprisn 24 HC in 77 weight percentage of a commercially available polypropylene resin (type Borcom™ BG055AI from the Borealis company) using 3 weight percentage of a commercially available adhesion promoter on the basis of maleic anhydride (type Exxelor™ PO1020 from DownMobil Corporation company) and granulated. Standard test pieces were made from the compound obtained in this way using an injection molding machine of the type Engel Victory 80, according to ISO 3167. The material properties which were measured are shown in table 1. FIG. 2 shows the even distribution of the powder in the matrix on an x-ray photo of the compound body obtained.

### Example 6

### Comparative Example

Example 5 was repeated whereby, instead of the regenerated cellulose powder, siliconised Lyocell short-cut fibers were blended in (TENCEL® from Leming AG) with an average individual fiber diameter of 10 μm and a length of 8 mm. So as to be able to meter this material into the extruder, it was first of all pelletized in a flat matrix press (manufacturers Messrs. Amandus Kahl, Hamburg). The siliconisation is necessary so that the pellets in the extruder and/or in the injection molding machine become disintegrated again and the pressed individual fibers distribute evenly in the matrix polymer. The measured material properties are listed in table 1. These properties are good but the siliconisation and pelletizing mean a considerable additional effort which cannot be justified in many applications.

### Example 7

### Comparative Example

Example 5 was repeated whereby a commercially available finished polypropylene compound was processed with adhesion promoters and 20 weight percentage glass fibers (individual fiber diameter of 14 μm, length of 4.5 mm) of the Borealis Company directly according to ISO 3167 to standard test bodies. The measured material properties are shown in table 1.

### Example 8

### Comparative Example

Example 5 was repeated using natural fibers of Sisal with an individual fiber diameter of >20 μm. The individual fiber lengths were considerably irregular in accordance with the origin. So as to be able to meter this material into the extruder at all, it was first of all pelletized in a flat matrix press (manufacturers Messrs. Amandus Kahl, Hamburg). The measured material properties are shown in table 1.

### Example 9

### Comparative Example

Example 5 was repeated whereby, however, instead of the regenerated cellulose powder, commercially available cellulose I-powder of the type PWC500 from J. Rettenmaier &. Söhne GmbH+Co. KG of ground pulp was blended in for the reinforcement of plastics with an average individual fiber diameter of 35 μm and an average length of 500 μm. The powder was easy to meter. The measured material properties are shown in table 1.

### Example 10

Example 5 was repeated whereby, however, the share of Lyocell powder was increased to 33 weight percentage so that the compound material produced from this blend, revealed the same specific weight as the material in example 7. The results of the measurements performed, which should test the power of performance of the compound materials, can, in this manner, be compared in a density-neutral way (results see table 1). The tenacity and break strength (un-notched) were considerably higher than in the glass fiber reinforced plastics in example 7 given the same good other mechanical properties.

### Example 11

### Comparative Example

20 weight percentage of the regenerated cellulose powder obtained in example 4 was mixed into an extruder Thermoprisn 24 HC in 77 weight percentage of a commercially available polypropylene resin (type Borcom™ BG055AI of Borealis) using a 3 weight percentage of a commercially available adhesion promoter on the basis of maleic anhydride (type Exxelor™ PO1020 of Exxon/Mobil Corporation) and from this standard test bodies were made using an injection molding machine of the type Engel Victory 80 according to ISO 3167. The measured material properties are listed in table 1. They are at a low level, comparable with pulp fibers of the same thickness (example 9) or compound bodies obtained from similarly thick Sisal natural fibers (example 8).

TABLE 1
Mechanical properties of fiber-reinforced compound materials

| | | | | | Impact | Impact | Heat |
|---|---|---|---|---|---|---|---|
| | | | | | resistance, | resistance, | dimensional |
| | Fiber share and | E-Modulus | Tear strength | Elongation | unnotched | notched | stability |
| Example | material | [Mpa] | [Mpa] | [%] | [kJ/m²] | [kJ/m²] | HDT-B [° C.] |
| 5 | 20% TENCEL-Powderr | 2962 | 52.01 | 6.98 | 43.15 | 4.47 | 143.3 |
| 6 | 20% TENCEL-short- | 3253 | 57.9 | 5.6 | 45.84 | 4.91 | 159.0 |
| | cut | | | | | | |
| 7 | 20% Glass fiber | 4801 | 66.68 | 3.02 | 39.78 | 7.32 | 159.1 |
| 8 | 20% Sisal, | 2771 | 35.1 | 3.53 | 17.49 | 3.87 | 133.4 |
| | diameter >20 μm | | | | | | |
| 9 | 20% Cellulose-I- | 2975 | 42.93 | 6.34 | 28.89 | 2.51 | 142.6 |
| | Powder | | | | | | |
| 10 | 33% TENCEL-Powder | 4266 | 72.4 | 4.73 | 54.79 | 7.6 | 161.9 |
| 11 | 20% TENCEL-Powder | 2677 | 39.49 | 4.45 | 24.04 | 2.4 | 146 |
| | (diameter 35 μm) | | | | | | |

What is claimed is:

1. Cellulosic man-made fibers for use in fiber-reinforced plastics characterized in that they have an average diameter of between 5 and 20 μm and a number-weighted average length of between 200 and 800 μm.

2. Cellulosic man-made fibers according to claim 1 characterized in that these are high-tenacity cellulosic man-made fibers.

3. Cellulosic man-made fibers according to claim 1 or 2 characterized in that they belong to the Lyocell generic fiber type.

4. Use of cellulosic man-made fibers for the production of compound materials of thermoplastic polymers whereby the fibers are metered into a mixing aggregate and there they are evenly distributed in the thermoplastic polymer characterized in that the cellulosic man-made fibers are used with an average diameter of between 5 and 20 μm and a number-weighted average length of between 200 and 800 μm.

5. Use according to claim 4 whereby other fiber materials, in particular pulp and/or natural fibers are mixed in to the compound substance in addition to the cellulosic man-made fibers.

6. Use according to claim 4 whereby the thermoplastic polymers are thermoplastics based on crude oil in particular polyolefines such as homo- or copolymers of polyethylene and polypropylene and their blends, polyester, polyamide, polystyrene and thermoplastic elastomers (TPE) and other impact-resistant modified polymers.

7. Use according to claim 4 whereby the thermoplastic polymers are completely or partly on the basis of thermoplastics based on renewable raw materials in particular polylactic acid (PLA), blends of co-polyester and PLA, polyhydroxyalcanoate (PHA), for example polyhydroxybutyrate (PHB), starch and starch-based polymers, polyvinylalcohol-co-vinylacetate-copolymers, polyvinylalcohols, polyvinylbutyrate, using polytrimethyleneterephthalates or polyols made from renewable raw materials, and bio-degradable blends of starch and polyester.

8. Process for the production of man-made fibers according to claim 1 characterized by the following steps:
a. Providing commercially available textile cellulosic man-made fibers with an average diameter of between 5 and 20 μm and a length of between 5 and 200 mm, preferably between 20 and 60 mm
b. Comminuting of man-made fibers using a precision cutting mill

9. Process according to claim 8 whereby the provision in step a) takes place in bale form and the fibers are opened with a bale opener prior to comminuting
